(19) United States
(12) Patent Application Publication
(10) Pub. No.: US 2008/0236039 A1
(43) Pub. Date: Oct. 2, 2008

(54) Plant growing container with internal water reservoir

(76) Inventor: William T. Warren, Prescott, AZ (US)

Correspondence Address: WILLIAM T. WARREN, 2126 CHARTEROAK DR., PRESCOTT, AZ, 86305, US

(21) Appl. No.: 11/651,606

(22) Filed: Mar. 26, 2007

(51) Int. Cl. A01G 9/02

(52) U.S. Cl. 47/65.5

(57) ABSTRACT

This container extends the watering cycle of plants. In some cases, plants may actually be revived and become healthy even after severe dehydration. This container is designed with a water reservoir built into the bottom. Holes on the side of the container allow excess water to run out. An insert that may or may not be porous to water is placed on the bottom of the container with the round ends sitting on the shoulder. Projections from the insert may or may not project through the holes. The top of the insert forms a surface limiting plant root growth: in effect, air pruning. The soil in the void areas, on each side of the insert, wick water to the soil mass. Using this container can greatly reduce the amount of water and nutrients consumed by the grower and significantly extend plant life in retail stores or other locations.

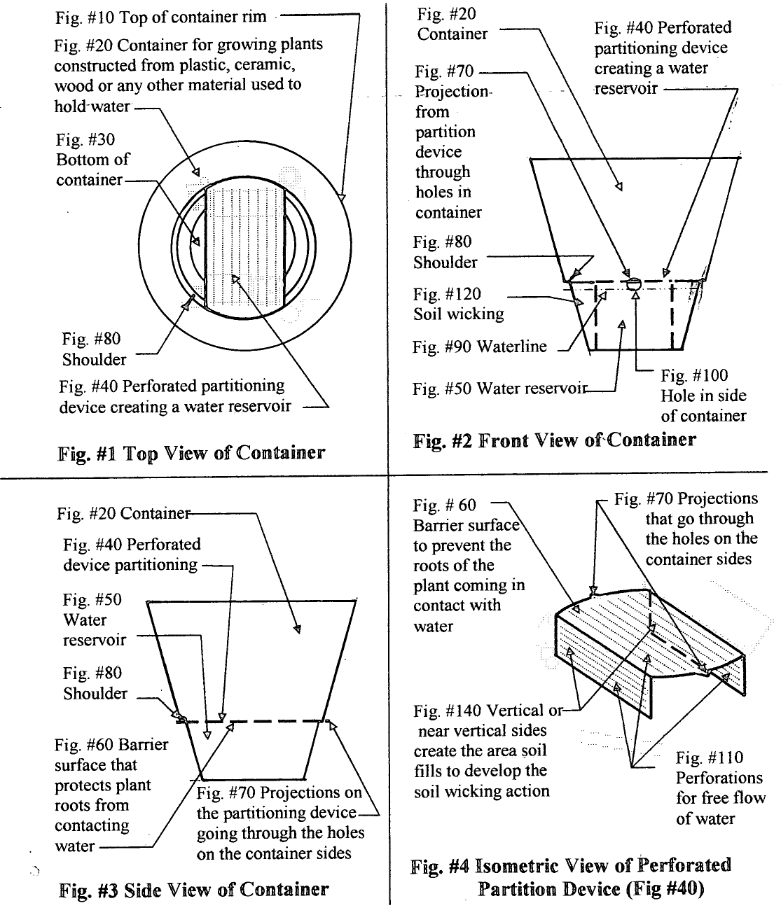

FIG. 1 Top view of container

FIG. 2 Front view of container

FIG. 3 End view of container

FIG. 4 Isometric view of partitioning

### DETAILED DESCRIPTION OF THE PREFERRED EMBODIMENTS

FIG. 1 Top View of Container

The Top View is looking down at the top of a plant growing container (Fig. #10). This container may be square, cylindrical or cone-shaped (Fig. #20) containers can be of any shape, or from any material and in any size. The perforated partitioning device (Fig. #40) is seen as a rectangle with rounded ends conforming to and sitting on the container shoulder (Fig. #80). The rounded ends are shown up on the side of the container because the top of the partitioning device is above the bottom of the container.

FIG. 2 Front View of Container

The dotted lines are the partitioning device (Fig# 40) in place in the container. The water reservoir (Fig. #50) caused by the partitioning device, is identified. The top of the water reservoir (Fig. #90) is shown. The wicking area (Fig #120) where the capillary effect takes place is shown. The partition device may have none, one or more projection(s) (FIG. #70) protrude through an opening in the side of the container as identified. Depending on the material of the container and or partitioning device material these projections may not be needed. The shoulder (Fig #80) around the container is shown.

FIG. 3 Side View of Container

The container with the partitioning device (Fig #40) (dotted line) is shown extending from side to side of container (Fig #20) and setting of the shoulder (Fig. #80). The water reservoir (Fig #50) is identified and the partition device's projections (Fig #70) are shown projecting through the holes in the container are clearly shown.

FIG. #4 Isometric View of Partitioning

The perforated partitioning device (Fig #40) is shown outside of the container. The horizontal barrier (Fig #60) prevents the plant roots from standing in water is identified. The vertical elements (Fig #140) that provide support for the horizontal barrier also separate the soil and water reservoir and provide the soil for capillary action inside the container are shown in this view. The ends of these vertical elements may be tapered as required (Fig # 150) to uniformly fit tightly to the sides of the container. The projections (Fig #70) that go through the container holes to hold the partition device in place, if needed, are shown.

How to Use:

The unique element in this invention is the partitioning device for an internal water reservoir inside a container for growing plants. A water-wicking action of the soil is built into the container to provide capillary action. Through capillary action, the water is made available to plants on an “as needed” basis for their growth. A barrier is provided to isolate the plant roots from being in contact with the water reservoir. The barrier partitioning device has holes to allow water to move freely through the barrier material. The reservoir is created by partitioning off a portion of the container's interior. One or more holes in the side(s) of the container, below the horizontal barrier, are required to allow excess water to freely flow out. The design of this reservoir partitioning device can be applied to any size or shaped watering container. The reservoir partitioning device may or may not be removed when the plant is removed from the container.

1. Plant growing containers with Internal Water Reservoir greatly reduces the frequency of watering; and increases the profitability of wholesale nurseries.
